(19) United States
(12) Patent Application Publication
(10) Pub. No.: US 2007/0011087 A1
(43) Pub. Date: Jan. 11, 2007

(54) System and method for providing object-oriented tag assisted trading

(75) Inventor: Heikki Waris, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/178,701

(22) Filed: Jul. 11, 2005

(51) Int. Cl. G06Q 40/00

(52) U.S. Cl. 705/39

(57) ABSTRACT

A system and method for providing an auction feature for use in mobile terminals. The present invention involves the reading of RFID and/or visual tags, as well as universal encoding of product models and parameters, and a personal payment system. The present invention, through individual client terminals and central servers, manages users' auction activities. The management of auction participant authorizations is developed as a new operator network service. The result is a value added feature that allows users to arrange exchanges (trades or other transactions) of products and/or services.

### BACKGROUND OF THE INVENTION

The present invention relates generally to peer-to-peer trading systems. More particularly, the present invention relates to Internet-based, peer-to-peer auction mechanisms.

### BACKGROUND OF THE INVENTION

Manufacturers currently market mobile terminals to emerging markets typically by lowering costs but relying on features that have proved popular in developed markets. This approach neglects the important consideration that poor individuals in developing markets often have other priorities than entertainment, such as finding affordable consumer products and services in their neighborhood.

The worldwide production and distribution of new products and services is quite efficient in most developed markets through the retail level. However, the logistics is often sub-optimal for used products, garbage, and/or underdeveloped markets. There is often too little incentive to design commercial systems that would be tailored for markets with a high variety of items (in terms of life models, positions in life cycle, physical condition, physical location, ownership, etc.), low price tolerance for consumers of the logistics service, and poor control of the participants of the potential logistics chain (reliability, trustworthiness and related issues of tolerance of disruptions and fraud). It is difficult to create automation and thereby attain economies of scale in such an operating environment.

The above issues unfortunately cause system providers and users to ignore human labor that could be utilized in order to provide such services, if there were a way to manage the related transactions and establish trust between the participants of the logistics and the trading system. While appropriate mechanisms are in place in most underdeveloped markets, they may not be suitable for new urban populations who cannot rely on kinship or other means of trust between market actors. Also the versatility of available products and services is much higher in modern consumer societies than in agricultural societies, and therefore it is not as easy to match the supply and demand.

Furthermore, the current economic system based on virgin products and unused waste cannot scale to the combination of population densities and low purchasing power that is found in many poor areas of the world's rapidly growing urban metropolises; manual separation at dumping grounds is possible but inefficient. Commuting costs in terms of money (up to half of income) and time (several hours per direction) already create differences in the pricing of products and services.

There are a number of conventional systems in existence that partially address some of the above-identified issues. These systems include (1) web-based auction systems such as eBay and Yahoo auctions; (2) the encoding of pointers and locators into radio frequency identification (RFID) tags or other tags and reading them with appropriate mechanisms; (3) location detection and geographic service scopes, i.e., filtering query results by object location; and (4) inventory management and logistics systems such as those used in retail store chains.

### SUMMARY OF THE INVENTION

The present invention involves the extension and automation of p2p web-based auction mechanisms. The use of registered tags as descriptors of auctioned products and services allows users to ignore the time consuming work of locating and inputting necessary information on auctioned items. This use also provides a standardized way for classification and comparison of the items. According to the principles of the present invention, a local public sector can pay a cellular operator for operating and managing an auction server, with the authorization and conflict resolution tasks related to that taken care of by public or private sector employees. The principles of the present invention also allow for the creation of consistent user interfaces for the system, which makes it easier to use the system of the present invention. The registered tags allow for the auction of products and services with fine granularity, which therefore increases the overall value of the trading system. The bootstrapping of the present invention to cellular user identities and operator billing systems, and the exploitation of geographic proximity during the transaction completion, can mitigate typical web auction problems such as fraud.

The system and method of the present invention also provides for many other benefits that cannot be achieved with conventional systems. Particularly in developing markets, if a terminal can be used as a tool for income, the net effect resulting from buying of the terminal may be positive, i.e., the user will make a profit by using the terminal. The present invention can therefore provide new opportunities for expansion of the mobile terminal and cellular telephone markets. The present invention also follows the Maslow's need hierarchy of needs by trying to provide for physical needs such as food, water, dwelling and waste hygiene first before aiming for higher needs such as entertainment.

By combining already existing components and utilizing ubiquitous mobile terminals and cellular infrastructure everywhere where such populations of urban consumers exist, low income consumers can be aided in finding affordable products and services. Such an implementation also improves the efficiency of reprocessing of consumer product waste and creates vast opportunities for new microeconomic activity, including new methods of employment as parts of the expanded logistics chain.

The use of an object-oriented hierarchy also results in a number of significant benefits. The use of such a hierarchy enables various administrative organizations to administer ratings, such as trust ratings, for various object groups within particular geographic regions. The hierarchy also enables a lightweight, simple implementation of a transaction system where transactions can be conducted without any intervention from a base infrastructure. The lightweight user interface that is used to conduct transactions can be used for any size or type of object being traded. Furthermore, tag identifiers arranged in accordance with such a hierarchy reduce or even eliminate potential ambiguities in product or service identifications, and such a hierarchy makes it easier for individuals to use proxies when completing transactions.

In terms of particular benefits to individual users, the benefits of the present invention are numerous. By taking advantage of the information and resources available to mobile terminals, such as location, authentication and payment, as well as the ability to carry the terminal to the place of a transaction, allows great simplification of the resolved alternatives with a better match to the user's preferences. The present invention also permits trading within a specific geographical area, which allows lower margins for participants. Many trades would be uneconomical if there is an overhead for transportation across the country or even the city, especially if there is no competitive industry for such services or if the value of the trade target is low. On the other hand, if the trade can be conducted within an easy walking distance of the trading parties, the only cost is time and effort, which especially in poor developing markets may be low. Furthermore, the efficient reuse of second hand products reduces waste and raises the living standard of the area without need for new products, or at least with less warehousing and the risks related to it. End users such the elderly, homemakers and other people who may have use for simple but laborious tasks can all benefit from the implementation of the present invention.

The present invention also provides for new opportunities in service provisioning and trading for entrepreneurs, as well as increased business for cellular operators as certificate authorities and payment providers. In particular, by building an efficient auction service from existing terminal software components, individual users can make money with their terminals instead of spending it. In terms of services (as opposed to products), the present invention allows for direct service provisioning by individuals, which reduces local unemployment and encourages small scale entrepreneurship. A public sector system incorporating the present invention can also tax individual transactions. Additionally, the present invention provides significant benefits over conventional web auction systems, which cannot reach the same level of usability when integrating the product into existing terminals and operator services.

Lastly, the present invention permits the extension of efficient market economies and their benefits to populations and areas where it has not been possible earlier because of high overheads, lack of security, and other constraints. This is due primarily to the negligible added cost of trading-related data transfers, and the incorporation of individuals within the overall trading mechanism who can span the gaps in the social and economic fabric of the respective areas.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1;

FIG. 3 is a flow chart showing an implementation of one embodiment of the present invention; and

FIG. 4 is a representation of a generic network in which the present invention may be implemented.

### DETAILED DESCRIPTION OF THE PREFERRED EMBODIMENTS

The present invention allows individual users to select and verify peer-to-peer trading transactions, including acting as relays for machine-to-machine transactions that cannot take place autonomously. The present invention involves the use of a tag, such as a RFID tag, a regular or two-dimensional barcode, or a visual or audio pattern (including optical character recognition (OCR) and the recognition of dynamically displayed graphics). The tag can be read and interpreted by a mobile terminal that has appropriate input interfaces and software to process the tag.

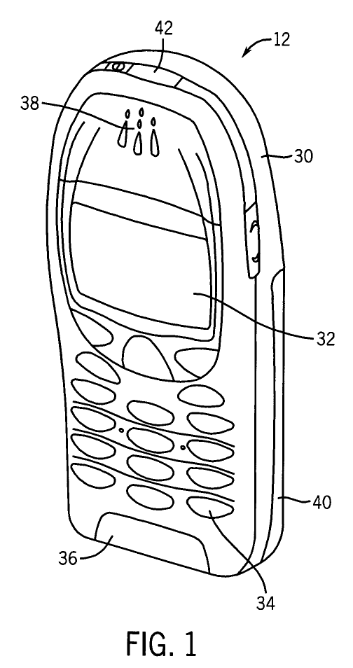

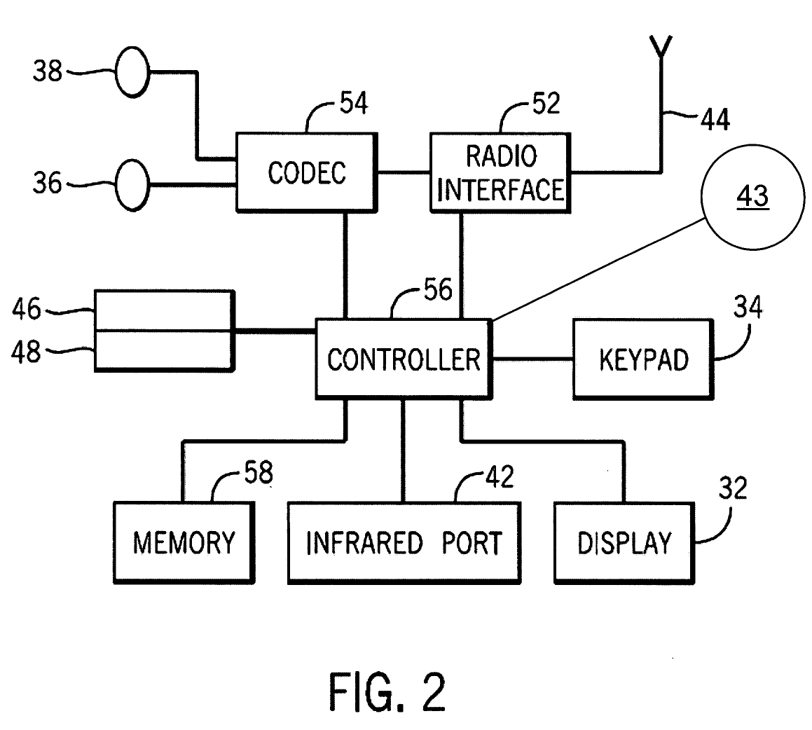

FIGS. 1 and 2 show one representative mobile telephone 12 within which the present invention may be implemented. It should be understood, however, that the present invention is not intended to be limited to one particular type of mobile telephone 12 or other electronic device. The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a system clock 43, a card reader 48, radio interface circuitry 52, codec circuitry 54, a controller 56 and a memory 58. Individual circuits and elements are all of a type well known in the art, for example in the Nokia range of mobile telephones.

In one embodiment of the invention, the tag takes the form of a composite tag, where the components are different tag types and combined only in a terminal that is able to read both of them and associate them with each other. For example, a tag for a printer could consist of a RFID tag that identifies the object type, ID and default properties, while dynamic information is read with OCR from a small liquid crystal display (LCD).

For each tag, there is also an object-oriented structure that describes the object at issue. The tag may include a plurality of separate fields that allow processes to operate by using only the needed information. One relevant field type would address the type of object at issue. In many situations, this may be the only necessary field type. In one embodiment of the invention, the field type includes an object-oriented sub-structure so that each nested type field inherits properties from its parent field and adds some properties of its own. The field type could also aggregate different types, such as how a television could comprise physical product and embedded software objects.

In some cases, such as with MAC addresses, the field type can be translated from the number space that a manufacturer has assigned for use in the particular type of products from its range of unique IDs. In this situation, the field type can contain a type-specific prefix and a unique suffix, although there is no official hierarchical type structure. In other cases (e.g., barcodes, electronic product code (EPC) RFID tags with manufacturer, product, version, and serial number fields), there is a similar structure that currently exists, although the tags are not designed for compatibility between manufacturers of the same types of objects.

Each tag may also include a unique identifier of the object. This unique identifier can be used when concluding an already negotiated trade (e.g., to make sure that the object is not stolen). In other situations, however, the type and model information for a product should be sufficient for the transaction, following the object-oriented tag structure; when participants can reach each other directly in their physical proximity, there is also no need for identifiable contact information. Locations copied from the user's terminals are enough. If the tag can restrict who is capable of reading the tag, this information could be provided in encrypted form so that only authorized readers can read it.

Each tag can include detailed object information that is not part of object type, but instead describes type-specific properties. For example, a bar code that describes a television program schedule and channel need not contain an object type because the user selects the type manually (e.g., using a specialized reader). This can be encoded into the serial number field unique to the object or in a similar location. Each tag can also include dynamic information that only appears in specific circumstances, such as an error code. This type of information can be specific to the type of object, and is likely to be read from a different type of tag besides the object ID.

The present invention also includes an object-oriented structure for actions that can be performed on the tagged object, based upon the type of object. This allows for the creation of consistent and easy-to-learn interfaces for most common actions performed on any traded objects. Part of this is covered by prior art, such as the EPC related ONS and PML, and can be utilized in the overall system. Even in a resource constrained, low performance mobile terminal, much of the required logic can be stored locally. Detailed object information that is not inherited from parent objects can be fetched from network servers and cached if used frequently. Examples of actions that can be performed on objects are listed below:

TABLE 1

| Object | Potential Actions |
|---|---|
| Root object | sell, buy, exchange, cancel |
| Service child object | supervise, apply provider certificate |
| Product child object | rent, lease, repair, upgrade |
| Physical product grandchild | transport, insure |
| object | |
| Data product grandchild | send, verify, delete, backup |
| object | |

In addition, other properties are also manageable alongside the action selection. Some of these properties apply generally to most tags, while other properties are specific to particular actions. Some examples are listed below:

TABLE 2

| Action Property | Property Options |
|---|---|
| Tag Management | add tag component, add separate tag, |
| | store tag creation state, revive tag |
| | creation state, clear tag creation state |
| Amount of objects requested | fixed number, unlimited, or certain |
| or offered | amount per unit of time |
| Other user inputted parameters | price limits, geographic location limits, |
| for the chosen transaction | required level of trust, required level of |
| | automation for the transaction agent |

The present invention also involves the use of a personal inventory management mechanism. Using this mechanism, users may store all items (both product and service objects) that are likely to be processed with the trading system. Therefore this mechanism basically serves as a tag management system. The relevant inventory entries need not be stored in the terminal; instead, the inventory mechanism can be used at the time of transaction or trade preparation for temporary input of necessary information regarding the objects. This personal inventory management mechanism can aggregate multiple tags as a descriptor for an inventory (and transaction) object. Users can bundle items that represent different aspects of the same product or service, or items that are feasible to combine for the purpose of inventory management or an intended transaction. The mechanism can also manage remote operations based on a stored inventory. When the tag information has been stored in the terminal's inventory, the user can perform most actions on the related objects without the need of proximity to the tagged items.

The present invention also involves the use of a tag user interface (UI) for selecting the objects, actions and parameters related to inventory management, trades or other transactions. The user interface utilizes the object-oriented tag and action hierarchy to reduce the amount of descriptions that needs to be fetched from the network. It also provides a hierarchy for the separation of selectable, navigable actions and property options that are applicable to the object at hand. This system can use common user interface designs, and can incorporate a variety of functions. For example, the user interface can sort the list based on the detection of the tag contents, where a detected tag indicating an error code gives precedence to the option of repairing the error or buying a new item. The user interface can also permit the user to save an incomplete trade request or response (e.g., in order to allow reading of a subsequent tag at a later point in time). The user interface can also provide notifications of requests, offers and matches depending on the level of automation for the agent selected by the user for the transaction.

According to one embodiment of the present invention, the terminal client creates the requests and responses from the tags and actions selected by the user and sends them to an auction server. This can use, for example, existing markup languages or session initiation protocol (SIP). The server process then matches of the user requests and responses (i.e., the demand and the supply of the targeted objects).

There are two elements that are particularly important in the invention. The first element is the locations of the transaction objects, which are copied from the location of the user terminal unless the user specifies a particular location. Because the mobile terminal location can be estimated and appended to the transaction messages automatically (and is expected to be always available), this can be a default criterion for all trades. This arrangement allows for the omission of contact information from the transaction details, because the participants are physically nearby and can reach each other directly by foot or other pedestrian means if necessary. Because the user information is not given to other transaction parties, a user's digital privacy is preserved. A physical location may also be more accurate in some urban areas where there are no accurate addresses due to a lack of city planning, or where complex addressing systems make the use of addresses by users difficult.

The second element comprises the reliability of the transaction participant as a user selectable parameter. Some traditional web-based auction sites use reputation metrics as a mechanism for the user to assess the trustworthiness of the trading counterpart. While such systems could obviously be improved by adding certificate infrastructure and explicit authorization of auction participants, it would reduce the volume of trade and therefore profits of the auction service. For the low purchasing power target market of the present invention, even low value objects may represent a large share of their total property and not just a small portion of discretionary spending. For such users, it is important to improve the reliability of each trade. For the target market of service consumers, product liability issues are more difficult to handle than with material products and therefore prior trust is also important. The reliability can be classified depending on the object type, so that a person buying an item could, for example, select the required level of trust from sorted lists. For example, a municipal authority may assign trust levels 1, 2, 3, 4 and 5 for transaction system participants trading healthcare services (which would be in one part of the object-hierarchy, referred to herein as X) within a city's limits (which would be in a second part of the object hierarchy, referred to herein as Y). Healthcare services in the consumer area would fall within a subset of X. The trust levels for healthcare services, whether consumer or otherwise, would be specifically set for the services in group X. Trust levels for other types of services and products would be set according to the particular group of products and services.

A more specific example of a type of sorted list involves communal services. These can be sorted for municipalities, certified providers, providers with no certified criminal history, authenticated providers, unknown or untrusted providers, and others. A second type of sorted list can involve the material product. Such a list can be sorted for manufacturers or their representatives, certified dealers, businesses with no criminal history, authenticated businesses or individuals, unknown or untrusted businesses or individuals, and others.

The authentication and authorization of the trading parties is based on cellular operator infrastructure and unique subscriber identities, although this could also be a separate, public or private sector authority. The precedence of transactions with geographically nearby participants makes it possible to use locally authoritative entities without scaling problems, although they could in turn form a hierarchy similar to certification authorities.

The authorization of participants of the trading or transaction mechanism is a combination of an out-of-band bootstrapped trust and ad-hoc reputation metrics based on the transaction history of identified and authenticated users. This approach creates an object-oriented trust hierarchy where the entities that authorize product and service traders can be limited in both geographical and trade object type scope. This requires a stored or cached list of relevant authorities, which can be configured to default settings or could be manually configured by users, or could require the system to access to root certification authorities that can then authorize the certification authorities hierarchy to the reduced scope authorities.

The network service portion of the present invention matches the supply and demand of the transaction objects by locating transaction counterparts and providing payment-related information. There is no need for detailed on-line contact information or verification of the traded contents. Information on user credentials can be kept private because the transaction participants will be notified of successful money exchanges between them.

Trade participants can supervise the transaction objects on-site and engage each other in case of suspect behaviour because the trade is conducted in their physical proximity of both participants. This allows for a simplification of typical auction mechanisms as follows: Payment is initiated by the recipient of the transaction object, and is verified after the completion of the transaction. The participants are in each other's proximity all of the time, and incorrectly advertised objects can be detected and revealed before the trade is conducted.

Transaction parties receive a notification when the money related to the transaction has been delivered to the correct party. Participants have less need for insurance or other risk management services related to the payment and related possibility of fraud, such as a separate clearing service. If either party is unhappy with the transaction, they can freeze and contest it. Whoever contests the transaction is then obliged to provide a reason to the certification authorities used in the transaction within a set period of time. The certification authorities can resolve the dispute and, as a result, adjust either party's trustworthiness for which it is responsible. If the certification authorities are not contacted, the transaction is completed. There is no need for separate notary services.

Trades can also be chained if there are persons willing to act as relays. This facilitates trades where one person is not able or willing to move all the way to the area where the trade would take place or is unwilling to take the risk of trading with someone who may have the object but is not trusted as much as the user would expect. The relaying person (i.e. trader) may take a fee for carrying part of the risk and for investing his or her own capital. In one embodiment of the invention, the auctioning system can automatically find such chains if it cannot find a direct match.

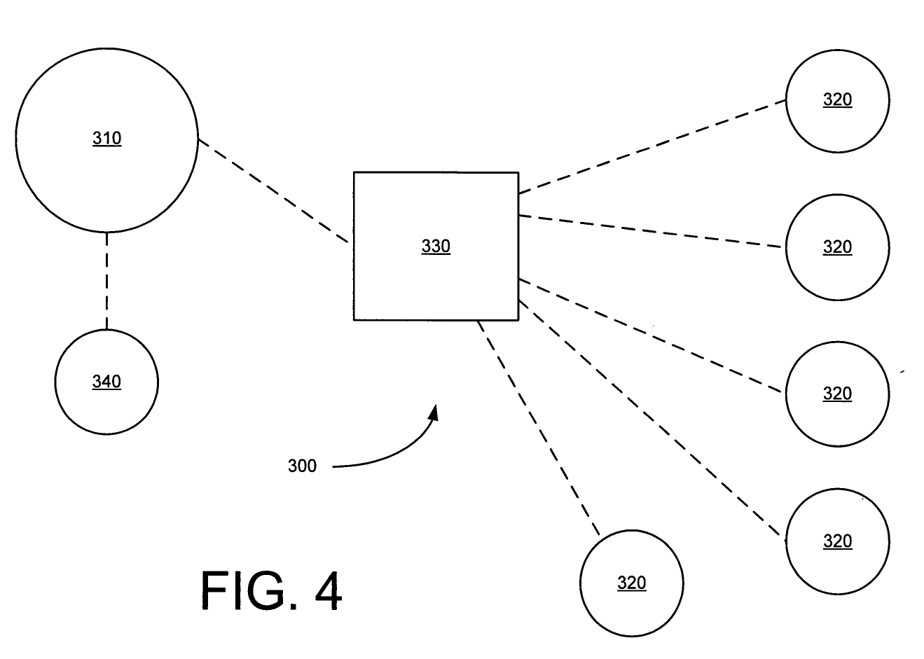

FIG. 4 is a generic representation of a network 300 in which the present invention may be implemented. The network 300 comprises a client terminal 310 and a plurality of potential transaction partner terminals 320. The client terminal 310 and the plurality of transaction partner terminals 320 are all capable of communication with an auction server 330 as is discussed below. It should be noted that the client terminal 310 can serve as a potential partner terminal 320 and vice versa in different transactions. Both the client terminal 310 and the partner terminals 320 can take the form of electronic devices such as mobile telephones, personal digital assistants, hand-held computers, integrated messaging devices, or other products.

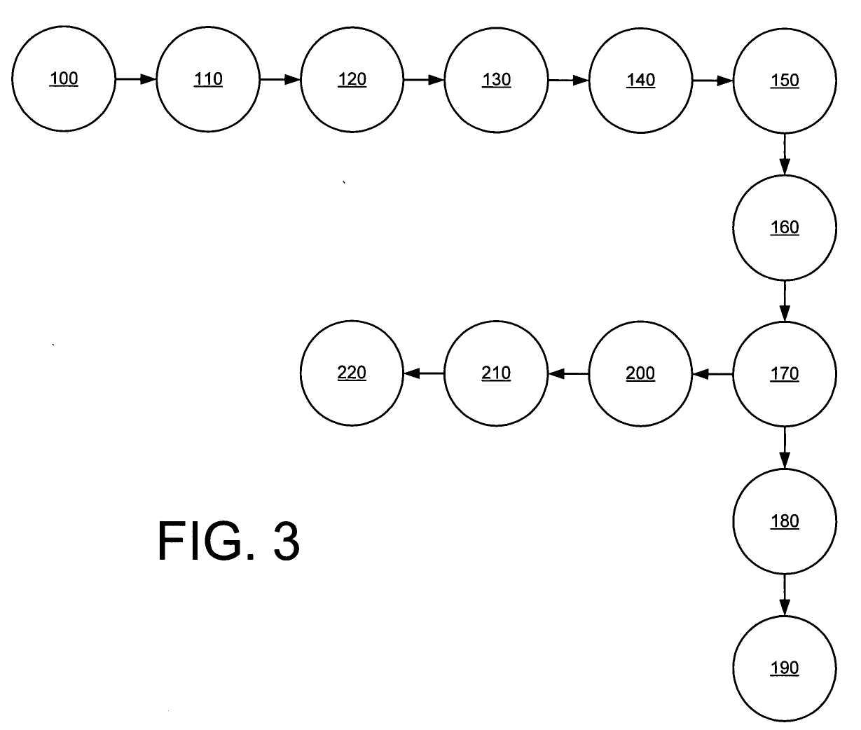

FIG. 3 is a flow chart showing one implementation of the present invention. In a product transaction scenario, a user who wants to buy or sell a product scans the product parameters from a tag 340 at step 100. At step 110, the client terminal 310 identifies the product type in an object-oriented hierarchy, where the transactions that can be performed with the object are associated product type. At step 120, the user selects the transaction and inputs parameters that are related to the transaction. The basic types and transaction alternatives can be stored locally in the client terminal 310, and less frequent types and transactions can be fetched from the auction server 330. At step 130, the user selects the geographic area where the transaction is to take place, as well as the required level of trust and reliability from a potential partner terminal 320. At step 140, the client terminal 310 then generates an auction request, sends it to the auction server 330 and waits for potential matches.

At step 150, the auction server 330 matches demand and supply requests from the client terminal 310 and the partner terminals 320 and transmits its proposed time and place for approval to the chosen parties. In this particular embodiment of the invention, the transaction by default begins when the participants meet physically and agree to conclude the transaction, confirming another stage of the process. This is represented at step 160. At step 170, the transaction value is then deducted from the purchasing party. At this point, final transfer for the transaction value to the providing party is still pending approval from the purchasing party. After approval is given at step 180, the payment is delivered to the providing party at step 190. Because the parties are in the same location, the verification of the product properties and transaction supervision is straightforward.

In case of disagreement about the transaction which is represented at step 200, final approval is not sent after the second stage confirmation. The purchasing party's money instead is frozen pending resolution of the conflict. At step 210, the transaction participant clients both send a resolution request to the auction system management, appended with related tag information. Managers, who also maintain the authorization of the auction system participants, may then revoke the rights of the guilty party and move the money to the proper person at step 220. The reputation of the system participants can, by default, only be modified as part of this resolution process in one embodiment of the invention, and not after the final approval.

In a scenario where service transactions are involved, the method of implementing the present invention is similar to the product scenario. In this case, however, tags can be “read” from printed leaflets that describe sets of common or typical services, such as home assistance services (grocery buying, cleaning, child sitting), home repair and renovation services (gardening, plumbing, carpentry), education services (language lessons, hobby teaching) or personal services (dating, companionship services, hospital visits). Other types of services could also be available, and some services may also be offered for free.

In addition to the above, the target of the system of the present invention can also be an aggregate of products and services. For example, a single item can comprise the service of grocery shopping along with a provided shopping list of products. In this scenario, the transaction can start before the participants have met if the purchasing party trusts the counterpart enough to submit the money to the auction system. Likewise, because the present invention can handle services, the rental of objects can be considered to be a service transaction, starting when the object is given to the purchasing party (and possibly verified at that stage by reading and storing its tag) and ending when it is returned to the providing party (with another tag read/store). In case of conflicts, resolution of conflicts can utilize the tag logs stored securely in the client terminal 310 as incomplete transactions, without the possibility for tampering by the terminal users.

Once the transaction has been completed, individual users may decide to store known counterparts in the client terminal 310. This can be used as a preference to the server in subsequent auction requests.

It should also be noted that, although the embodiment described above refers to an “auction” system, individual transactions do not necessarily need to be auction-based. Instead, the present invention can be implemented, for example, simply through the matching of corresponding “buy” and “sell” prices for identical or substantially identical services. In one embodiment of the present invention, both participants of the trade provide an object to be traded. The auction server may match their monetary values, or it may directly match one trade object against another without conversion to monetary units, if both trade participants have provided a list of substitute trade objects acceptable in exchange for their own object.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for conducting transactions between clients capable of connecting to a network through client terminals, comprising:
using a client terminal to register an item for potentially being subject to transaction by inputting digital information directly from a standard identifier, the standard identifier mapping the item according to a predefined object-oriented hierarchy;
designating the registered item for being subject to transaction;
setting a plurality of parameters in accordance with the predefined object-oriented hierarchy and with regards to potential transactions;
generating a transaction request based upon the item subject to transaction and the set plurality of parameters;
transmitting the transaction request to a network server;
receiving a plurality of corresponding transaction requests of other clients from the network server, the corresponding transaction requests matching the item subject to transaction and the set plurality of parameters according to the object-oriented hierarchy; and
generating a response to at least one of the plurality of corresponding transaction requests.

2. The method of claim 1, further comprising transmitting the response to server.

3. The method of claim 1, further comprising sending a transaction notification to the server relating to an physical meeting of the parties and the transfer of the item.

4. The method of claim 3, further comprising transmitting to the server a complaint indicating fraud from the other party subject to the transaction.

5. The method of claim 1, wherein the item comprises a tangible product.

6. The method of claim 1, wherein the item comprises a service.

7. The method of claim 1, wherein the item comprises digital information.

8. The method of claim 1, wherein at least one of the set plurality of parameters comprises a geographic area in which an originator of the transaction is willing to meet to complete the transaction, the geographic area being derived from a specified portion of the object-oriented hierarchy.

9. The method of claim 1, wherein at least one of the set plurality of parameters comprises a trust level required of a potential counterpart to the transaction, the trust level being derived from a specified portion of object-oriented hierarchy.

10. The method of claim 1, further comprising, after generating a response, charging an account of the user purchasing the item for an agreed-upon value.

11. The method of claim 10, further comprising, upon the entering of an approval by the buyer of the item, delivering payment for the item to the user selling the item for the agreed-upon value.

12. The method of claim 10, further comprising freezing the payment for the item in the event of a dispute regarding completion of the transaction.

13. The method of claim 12, further comprising generating a dispute resolution request based upon the dispute.

14. The method of claim 1, wherein the transaction is auction-based.

15. The method of claim 1, wherein the client terminal comprises a mobile telephone.

16. A computer program product for conducting transactions between clients capable of connecting to a network through client terminals, comprising:
computer code for using a client terminal to register an item for potentially being subject to transaction by inputting digital information directly from a standard identifier, the standard identifier mapping the item according to a predefined object-oriented hierarchy;
computer code for designating the registered item for being subject to transaction;
computer code for setting a plurality of parameters in accordance with the predefined object-oriented hierarchy and with regards to potential transactions;
computer code for generating a transaction request based upon the item subject to transaction and the set plurality of parameters;
computer code for transmitting the transaction request to a network server;
computer code for receiving a plurality of corresponding transaction requests of other clients from the network server, the corresponding transaction requests matching the item subject to transaction and the set plurality of parameters according to the object-oriented hierarchy; and
computer code for generating a response to at least one of the plurality of corresponding transaction requests.

17. The computer program product of claim 16, further comprising computer code for transmitting the response to server.

18. The computer program product of claim 16, further comprising computer code for sending a transaction notification to the server relating to an physical meeting of the parties and the transfer of the item.

19. The computer program product of claim 18, further comprising computer code for transmitting to the server a complaint indicating fraud from the other party subject to the transaction.

20. The computer program product of claim 16, wherein the item comprises a tangible product.

21. The computer program product of claim 16, wherein the item comprises a service.

22. The computer program product of claim 16, wherein at least one of the set plurality of parameters comprises a geographic area in which an originator of the transaction is willing to meet to complete the transaction, the geographic area being derived from a specified portion of the object-oriented hierarchy.

23. The computer program product of claim 16, wherein at least one of the set plurality of parameters comprises a trust level required of a potential counterpart to the transaction, the trust level being derived from a specified portion of object-oriented hierarchy.

24. a client terminal, comprising:
an input;
a processor for processing information; and
a memory unit operatively connected to the processor; the memory unit including a computer program product comprising:
computer code for using the client terminal to register an item for potentially being subject to transaction by inputting digital information directly from a standard identifier, the standard identifier mapping the item according to a predefined object-oriented hierarchy;
computer code for designating the registered item for being subject to transaction;
computer code for setting a plurality of parameters in accordance with the predefined object-oriented hierarchy and with regards to potential transactions;
computer code for generating a transaction request based upon the item subject to transaction and the set plurality of parameters;
computer code for transmitting the transaction request to a network server;
computer code for receiving a plurality of corresponding transaction requests of other clients from the network server, the corresponding transaction requests matching the item subject to transaction and the set plurality of parameters according to the object-oriented hierarchy; and
computer code for generating a response to at least one of the plurality of corresponding transaction requests.

25. The client terminal of claim 24, wherein the memory unit further comprises computer code for transmitting the response to server.

26. The client terminal of claim 24, wherein the memory unit further comprises computer code for sending a transaction notification to the server relating to an physical meeting of the parties and the transfer of the item.

27. A system for conducting a transaction within a network, comprising:
a plurality of client terminals, each of the plurality of client terminals including:
computer code for using the client terminal to register an item for potentially being subject to transaction by inputting digital information directly from a standard identifier, the standard identifier mapping the item according to a predefined object-oriented hierarchy;
computer code for designating the registered item for being subject to transaction;
computer code for setting a plurality of parameters in accordance with the predefined object-oriented hierarchy and with regards to potential transactions;
computer code for generating a transaction request based upon the item subject to transaction and the set plurality of parameters;
computer code for transmitting the transaction request to a network server;
computer code for receiving a plurality of corresponding transaction requests of other clients from the network server, the corresponding transaction requests matching the item subject to transaction and the set plurality of parameters according to the object-oriented hierarchy; and
computer code for generating a response to at least one of the plurality of corresponding transaction requests. and
the network server for interacting with the plurality of client terminals.

28. The system of claim 27, wherein the item comprises a tangible product.

29. The system of claim 27, wherein the item comprises a service.
